(19) United States
(12) Patent Application Publication
(10) Pub. No.: US 2009/0181126 A1
(43) Pub. Date: Jul. 16, 2009

(54) Animal Feed Product From Distillers' Grain

(75) Inventors: Jeffrey Bruce Wicking, Bayview (AU); Kenneth B. Kaplan, West Des Moines, IA (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Cellencor, Inc.

(21) Appl. No.: 12/013,973

(22) Filed: Jan. 14, 2008

(51) Int. Cl. A23K 1/06

(52) U.S. Cl. 426/61; 426/624; 426/623

(57) ABSTRACT

The present invention concerns systems, apparatus, methods and compositions for production of improved animal feeds from by-products of ethanol production or similar facilities, such as DDG or DDGS. In preferred embodiments, the methods may comprise initial removal of water by mechanical devices, pelletizing the material, and further water removal by microwave treatment. Optionally, various supplements such as enzymes, vitamins, minerals or other nutrients may be added. In more preferred embodiments, the action of the enzymes in breaking down complex molecules in the mixture is enhanced by microwave treatment. Most preferably, the mixtures are maintained at relatively low temperatures to preserve enzyme activity and/or nutrient and feed quality.

### FIELD

The present invention relates to methods, compositions and apparatus for animal feed products. In preferred embodiments, the animal feed products are formed from co-products of fuel ethanol production, particularly distiller's grain.

### BACKGROUND

Ethanol has become an important renewable energy source. In 2006 over 40% of the gasoline consumed in the United States of America (US) was a blend containing at least 10% ethanol content. Almost all ethanol is produced by the fermentation and distillation of biomass, particularly grains. In the US, corn is currently the most widely used feedstock.

Three important factors in renewable energy production are a) minimizing energy use in order to maximize the net energy gain, b) minimizing negative environmental effects incident to the production process, and c) maximizing the value of co-products.

Fuel Ethanol Production

There are two main industrial methods of producing fuel ethanol, wet milling and dry milling. The overwhelming majority of ethanol plants in the US use the dry milling process.

In wet milling, the incoming corn is first inspected and cleaned. Then it is steeped in water for 30 to 40 hours to begin breaking the starch and protein bonds. The next step is a coarse grind to separate the germ from the rest of the kernel. The remaining slurry consisting of fiber, starch and protein is finely ground and screened to separate the fiber from the starch and protein. The starch is separated from the remaining slurry in hydrocyclones. The starch is then used for the fermentation process. The other co-products are typically dried before use. Wet milling is a capital intensive and complex process used primarily in a few very large industrial processing plants.

In dry milling, the entire corn kernel is milled into a “meal”, and processed without separating out the various component parts of the grain. The meal is slurried with water to form a “mash.” A heat stable enzyme (typically α-amylase) is added to the mash to convert the starch to dextrose. In the next step, “liquefaction”, jet cookers inject steam to cook the mash above 100° C. This reduces bacteria levels and breaks down the starch granules in the kernel endosperm. The slurry is allowed to cool to about 80° C. and more a-amylase enzyme is added to further fragment the starch polymers. Finally, in a process called “saccharification”, the slurry is cooled to about 30° C. and a different enzyme (typically glucoamylase) is added which begins the conversion of the starch to sugar (glucose) which continues through the microbial fermentation process.

Both methods use similar fermentation processes. The starch or slurry is put in a fermentation tank, and yeast is added to convert the simple sugars to ethanol. After fermentation, the liquid slurry has an ethanol content of about 10% to 12% by weight. The slurry is distilled which produces a product that is about 95% ethanol by weight. The remaining water is typically removed using molecular sieves.

The residual product after distillation, referred to as stillage, consists of liquids (mostly water and some ethanol) and corn solids. A centrifuge is used to separate much of the liquid (called thin stillage) from the solids (called wet cake).

Some of the thin stillage is recycled to the beginning of the process. The remainder is processed by an evaporator to produce a thickened co-product called syrup. Most often, the syrup is blended back into the wet cake. After drying, the product is thus referred to as “distillers' dried grain with solubles”, or DDGS. Some local demand as animal feed may exist. However, most of the DDGS must be dried to 12% or less moisture content because otherwise the wet cake has a storage life of only two or three days. A large amount of DDGS is produced; a typical 50 million gallon per year dry milling ethanol plant will produce 166,000 dry tons of DDGS per year. The value of the DDGS can be critical to the economic success of the plant, but the cost of DDGS drying can be substantial and may reduce the economic return from DDGS sales.

Current DDGS Drying Techniques

The two most common types of dryers used to dry distillers' grains in the US utilize the rotary kiln dryer and ring dryer. The rotary kiln is by far the most popular type of dryer. About 85% of US ethanol plants use rotary kilns, with the remaining 15% utilizing ring dryers. The rotary kiln dryers produce a more granular product, whereas the ring dryer produces a finer particle DDGS.

Ring dryers operate by circulating the material being dried in a circular duct system. As the material dries, it becomes lighter and moves closer to the interior of the duct, where it is extracted from the air stream. Ring dryers use natural gas almost exclusively for heating. They also require electricity to operate the large fans needed to keep the distillers' dried grain (DDG) entrained in the air stream.

Rotary kiln dryers consist of a large cylinder that rotates at low speed. The interior surface of the dryer is covered with flighting that catches the DDG and lifts it up into the hot gas stream. As the cylinder turns, granular material falls from the flighting, allowing the individual grains to come into close contact with the hot gases, and resulting in the evaporation of water from the material.

Most rotary kiln dryers are direct fired by natural gas, although steam may also be used for heating the air stream. Due to the large amount of DDG and the off-center (15°) loading of the kiln, large electric motors are required to rotate the rotary kiln dryers. It is not uncommon to size rotary dryers to reduce the moisture content to 50% on the first pass through the rotary kiln dryer. Additional passes through a rotary kiln dryer are required to reach a moisture content of 10% for long term storage of DSG.

Utilizing direct-fired natural gas or liquid propane dryers eliminates the losses that result from isolating the distillers' grain from the combustion products with a heat exchanger. Aside from introducing a number of contaminates into the distillers' grain, such as nitrous oxides, nitrous acid, and formaldehyde, the failure of a burner to ignite can allow the rotary kiln to fill with natural gas, resulting in a considerable hazard.

The higher initial purchase cost of ring dryers has made them less popular than rotary kiln dryers. However, ring dryers offer several advantages over rotary kiln dryers, including: a) minimizing movement requirements—ring dryers move only the material being dried, whereas rotary kilns require rotating a large cylinder lined with refractory material; b) minimizing thermal loss—ring dryer insulation can be optimized to minimize these losses since the duct system is static; c) recirculating material automatically—eliminating the need to use additional conveyors for multiple passes; and d) utilizing a lower operating temperature—reducing (but not eliminating) the over-heating of distillers' grain and subsequent nutrient loss.

Ring dryers are not without their own operational concerns. A single fan is typically used to operate a ring dryer. The horsepower requirements are not commonly published as each ring dryer is a custom design. When estimating energy consumption for ethanol production, the US Department of Agriculture (USDA) uses an average value of 1,300 horsepower (975 kilowatts) for operation of a ring dryer fan for a 40 million gallon a year plant.

Both types of dryer share other problems. They are hard to control and may damage the DDG by burning. They are complex and notoriously unreliable, and are the primary cause of downtime at many plants.

Rotary kilns and ring dyers operate by heating air using natural gas. The wet cake product is circulated through the hot air. The hot air heats the surface of the product and heat is transferred through conduction. The heat transfer is limited by the maximum permissible surface temperature. Losses include a) the heat necessary to heat the air, b) considerable heat lost from the exhaust of the dryer, which is necessary to remove moisture and combustion products, and c) heat lost through the exterior surfaces of the dryer.

A major environmental problem for gas dryers is the generation of particulate pollutants. It is necessary to rapidly agitate the product in order to ensure uniform exposure to the hot air. This separates fine particles from the general mass, which are carried away into the dryer exhaust potentially causing environmental safety issues.

Energy Usage by Ethanol Plants

Most ethanol plants consume natural gas as a primary energy source and electricity as a secondary source. While natural gas is a “clean” burning fuel, it presents several problems to the ethanol industry. First, its cost has increased four-fold in the last 10 years, and its cost is forecast to rise further. Ethanol plant locations are usually chosen to be near the source of supply of biomass feedstock and typically natural gas supplies usually are not available nearby. It may add many millions of dollars of capital cost to a new plant in order to build a natural gas supply pipeline.

Currently, the ethanol industry estimates that it takes 34,000 BTU/gallon to produce ethanol. This includes 12,000 BTUs/gallon (plus 0.20 kilowatt hours of electricity) used in the DDGS drying process.

Considerable research and development has been underway to create renewable energy sources which replace natural gas in ethanol plants. An example is using waste biomass feedstock such as corncobs and stover to fuel fluidized bed reactors. Some pioneering ethanol plants are beginning to use this new technology. Unfortunately this technology shows little promise so far to be able to provide a heat source useable for drying DDGS.

Environmental Impact of Ethanol Production

The natural gas combustion processes currently used for DDGS drying process release greenhouse and other gasses into the atmosphere which adds significantly to the plant's carbon footprint. The US Environmental Protection Agency's AP 42 Compilation of Air Pollutant Emission Factors, Vol. 1, Section 1.4 states that “The emissions from natural gas-fired boilers and furnaces include nitrogen oxides (NOx), carbon monoxide (CO), and carbon dioxide (CO₂), methane (CH₄), nitrous oxide (N₂O), volatile organic compounds (VOCs), trace amounts of sulfur dioxide (SO₂), and particulate matter (PM).” In addition, much of the odor in the vicinity of an ethanol plant emanates from its dryer.

These contaminants increasingly require ethanol plants to install and operate remediation systems, most commonly thermal oxidizers, which are costly to install, operate, maintain, and increase the consumption of energy.

Water use by ethanol plants is also of increasing concern. A typical 50 million gallon per year dry milling ethanol plant consumes about 200 million gallons of water. Some recycling is done, primarily by feeding thin stillage back to the slurry; however, much of the water used is lost to the atmosphere during the DDGS drying process.

Characteristics of the DDGS Co-Product

DDGS is a rich co-product valuable for animal feed. DDGS is a high quality feedstuff ration for dairy cattle, beef cattle, swine, poultry, and aquaculture. The feed is an economical partial replacement for corn, soybean meal, and dicalcium phosphate in livestock and poultry feeds. Historically, over 85% of DDGS has been fed to dairy and beef cattle, and DDGS continues to be an excellent, economical feed ingredient for use in ruminant diets.

A typical analysis of corn DDGS includes: 30% crude protein, 11% fat, 12% fiber, and 48% carbohydrates. The composition and quality of DDGS can vary greatly from plant to plant and batch to batch. Some of the variables include the composition of the corn feedstock, the exact process used by the plant, and the drying regimen. This variability is a problem for marketers and consumers. In addition, the ability to enhance or tailor the product for a particular animal species by addition of enzymes and other nutrients is severely limited due to the high temperature of the drying process currently used which would destroy the additives.

It is difficult to bulk ship DDGS because it has significant natural adhesion, does not flow well, and compacts into hard clumps. When unloading trucks or rail cars filled with DDGS, it is often necessary for a worker to break up the product manually with a shovel. Most US railroads no longer accept bulk DDGS shipments, forcing ethanol plants to invest in their own rolling stock. Various problems exist with current DDGS production and processing methods, such as high utilization and cost of energy, co-production of various forms of pollution including greenhouse gas, and quality control issues in DDGS production. A need exists in the field for improved methods of processing DDG or DDGS.

### SUMMARY OF INVENTION

The present invention satisfies an unresolved need in the field by providing novel methods for processing DDG or DDGS that not only provide an improved usable material from a waste product but offers the possibility of building ethanol plants that do not require natural gas, thereby saving on energy costs for plant operation.

In a first aspect, the present invention provides a process for producing an animal feed comprising:
(a) treating distillers' grain to reduce moisture content;
(b) forming pellets from the treated distillers' grain; and
(c) exposing the pellets to microwave energy to reduce moisture content to form a pelletized animal feed.

In a preferred embodiment, the process further comprises:

(d) capturing and condensing vapors from the moisture removed during the moisture reduction process.

In a second aspect, the present invention provides a process for producing an animal feed comprising:
(a) adding a supplement to the distillers' grain;
(b) treating distillers' grain to reduce moisture content;
(c) forming pellets from the treated distillers' grain; and
(d) exposing the pellets to microwave energy to reduce moisture content to form a pelletized animal feed.

In a preferred embodiment, the method further comprises:

(e) capturing and condensing vapors from the moisture removed during the moisture reduction process.

The distillers' grain can be treated by any suitable dewatering method. Preferably, the distillers' grain is treated mechanically, for example using a vertical rotary or screw press to reduce moisture content from about 65% to about 55% (wt/wt). It will be appreciated that more or less moisture can be removed in this first step and that any alternative mechanical dewatering methods and apparatus known in the art may be utilized.

Pellets can be formed from the treated distillers' grain by any suitable pelletizing method such as using a low pressure extruder or a pellet mill. Preferably, the pellets are formed by a low pressure extruder.

The moisture content of the distillers' grain from an ethanol producing plant is typically around 65% to 70% (wt/wt). The moisture content of the formed pellets range from about 55% to 45% but is preferably the minimum that can be removed by the mechanical dewatering machine. The moisture content of the pellet animal feed ranges from 15% to about 10% (wt/wt).

Preferably, the microwave energy has a frequency in the order of 915 MHz. It will be appreciated that the frequency can vary, depending on the approved microwave frequencies used in different countries or regions of the world. A frequency of 2.45 GHz is typically available worldwide. The lowest frequency permitted by law in a given country is preferable.

Preferably, microwave energy exposure is carried out such that the temperature of the pellets is effectively controlled using a computer control system, temperature sensors, and moisture sensors. Typically, the temperature is from about 50° C. to less than about 90° C. Preferably, the temperature is about 60° C. to 80° C., or more preferably about 65° C. to 78° C. A temperature of around 70° C. has been found to be particularly suitable. Treating with microwave energy can be carried out in a continuous or batch manner. Preferably, the treatment is in continuous manner with several microwave ovens positioned in series through which the pellets pass on a conveyor system.

In certain embodiments, one or more enzymes may be added to the DDG or DDGS prior to pelletizing and/or microwave treatment. The microwave energy or irradiation may be utilized to enhance the action of the enzyme upon its substrate. The microwave frequency used in initial studies was in the order of 915 MHz. This frequency is available for use in Australia but other frequencies such as 2.45 GHz may also be used. The amount of microwave energy required is dependent upon the water or moisture present within the cellulosic material and enzyme mixture. The amount of microwave energy used is also dependent upon the type of material being treated as different cellulosic material can have different dielectric constants. Materials with high dielectric constants absorb microwave energy preferentially and are therefore heated or acted upon before compounds with lower dielectric constants. However, other heating mechanisms may be used to bring the enzyme solution and substrate up to the activation temperature of the enzyme at which point the microwave treatment can then be applied.

In a preferred form, the microwave energy is applied such that the temperature of the pellets is effectively controlled. Furthermore, it has been found that it is preferable to apply the microwave energy to the pellets in a continuous manner.

Time of microwave exposure will vary depending on the pellet size and moisture content, supplements added, and the volume of material to be treated.

In a preferred embodiment, supplements are added to the treated distillers' grain. Suitable supplements may include enzymes, vitamins, and minerals.

Preferably, the enzymes are selected from amylase, alpha amylase, glucoamylase, phytase, phosphatase, carbohydrate hydrolyzing enzymes, xylanase, cellulase and hemi-cellulase and mixtures and combinations thereof.

Preferably, the vitamins are selected from vitamin A, vitamin D, vitamins of the B Group and vitamin E and mixtures and combinations thereof.

Preferably, the minerals are selected from sodium chloride, calcium, phosphorus, sulfur, potassium, magnesium, manganese, iron, copper, cobalt, iodine, zinc, molybdenum and selenium and mixtures and combinations thereof.

The enzymes, vitamins, and minerals can be added at concentrations ranging from parts per million, in the case of enzymes or trace supplemental nutrients, up to 5000 g per 1000 kg of material. The optimal concentrations of various supplements for addition to animal feed, for different species of animals, are well known in the field of animal nutrition.

In a third aspect, the present invention provides a system for forming a pelletized animal feed from distillers' grain comprising:

mechanical dewatering apparatus for reducing moisture content of distillers' grain;

pellet-forming apparatus;

microwave oven; and

transporting system for moving material through the system.

In a fourth aspect, the present invention provides a system for forming a supplemented pelletized animal feed from distillers' grain comprising:

mixer for adding supplements to distillers' grain;

dewatering apparatus for reducing moisture content of distillers' grain;

pellet-forming apparatus;

microwave oven; and

transporting system for moving material through the system.

Preferably, the dewatering apparatus is a vertical rotary or screw press.

Preferably, the pellet-forming apparatus is a low pressure extruder.

Preferably, the mixer is integrated with the low pressure extruder.

The system may further include one or more devices for measuring moisture content of distillers' grain, pellets or pelletized animal feed.

The system may further include an exhaust apparatus for removing vapors from microwave oven.

The system may further include apparatus to collect moisture or water removed from distillers' grain or pellets.

Preferably, the system is under the control of a computer and appropriate software.

In a fifth aspect, the present invention provides a pelletized animal feed produced by the process according to the first or second aspects of the present invention.

In a sixth aspect, the present invention provides a pelletized animal feed produced by the system according to the third or fourth aspects of the present invention.

### DETAILED DESCRIPTION

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

As used herein, the term “about” means plus or minus ten percent of a recited value. For example, “about 100” refers to any number between 90 and 110.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this specification.

In order that the present invention may be more clearly understood, preferred embodiments will be described with reference to the following drawings and examples.

### BRIEF DESCRIPTION OF THE DRAWINGS

FIG. 1 shows an exemplary schematic of a system for forming a supplemented pelleted animal feed from distillers' grain according to the present invention.

FIG. 2 shows an exemplary detailed schematic of the microwave drying line for forming a supplemented pelleted animal feed from distillers' grain according to the present invention.

### MODE(S) FOR CARRYING OUT THE INVENTION

While the description of this invention uses corn as an example, the disclosed methods and apparatus may also be applied to other biomass feedstock such as rice, wheat, barley, sorghum, millets, oats, and rye.

In various embodiments, the present invention concerns a process to enhance, form and dry the distiller's grain co-product of ethanol production. There are five preferred processing steps as follows.

First, wet cake (distillers' grain) is optionally mixed with one or more supplements. Second, at least approximately 10% of the moisture content is removed from the distillers' grain by a mechanical dewatering device. Third, the product is formed into pellets by a low pressure extruder. Fourth, the product is dried using an industrial microwave dryer line. Fifth, optionally vapors can be collected from the drying process and condensed for recycling.

Conventional conveyors and material handling equipment can be used to move product from stage to stage. A computer system monitors and controls the overall processing line.

The present invention is suitable for application to newly constructed ethanol producing plants or may be retrofitted to existing ethanol producing plants.

### Starting Material

The initial material received is typically “wet cake” which consists of solids remaining after the fermentation process, water, and other liquids including ethanol. Typically the last stage of the ethanol plant's process line is a centrifuge which is used to remove liquids containing dissolved solubles. Unless dried or refrigerated, wet cake will spoil within 2 to 3 days. Various samples of the moisture content after the centrifuge have been measured to be 65% to 70% by weight. The literature indicates that this is typical industry-wide. The term “wet cake” is used herein to generally mean distillers' grain and the like being a waste product from ethanol producing plants.

### Supplements

In this stage, wet cake is received, typically via conveyor from the ethanol plant's centrifuge.

A commercial mixer is used to optionally add and mix in suitable supplements. Examples include a) enzymes selected for either general or species specific nutritional enhancements of the DDG end product and/or b) additional nutrients, for example but not limited to, vitamins and minerals which are selected to be either general or species specific. It is also possible to combine this step with the low pressure extrusion step.

It has been established (U.S. Pat. No. 6,274,178) that enzymatic treatment of the co-product material followed by microwave irradiation enhances its nutritional value.

An advantage of this optional step is that these enzymes and nutrients are not destroyed by the low heat (less than about 75° C.) dying process used, as compared to the high heat (over 250° C.) of current drying equipment.

The addition of supplements such as enzymes and nutrients is optional. It is also an option to mix additives in the product forming stage.

### Mechanical Moisture Removal

Removal of moisture by a mechanical process is far more energy efficient than heating processes. Although the ethanol plant's centrifuge removes bulk moisture, it is possible to perform additional moisture removal. It is preferred that this be accomplished at low temperature so enzymes and nutrients, if added, are not damaged or destroyed by excess heat.

Preferably, this is accomplished by use of a screw press machine or a rotary vertical press machine. Screw presses are used in many industrial applications including food processing, wood pulp processing, and waste treatment. A screw press has a horizontal screw with flights which increase in pitch from the intake to the outlet side. The screw shaft is tapered to increase in diameter from the intake side towards the outlet side. Except for an exposed area within the intake hopper where material feeds in, the screw is encased in a screened cylinder of constant diameter. The clearance between the outer edges of the screw flights and the screen is typically ten one-thousandths of an inch or less.

As material travels through the screened cylinder, its pressure is increased by the increasing pitch and increasing diameter of the shaft. Material is pressed against the screen and free moisture drips through. It is captured by a drip pan with a drain. A cone at the output end of the screened cylinder maintains pressure on the material. Output product is forced out through a small gap between the cone and the end of the screen cylinder. The pressure is variable and controlled by a pneumatic cylinder. The shaft is rotated by a variable speed electric motor through a gear reduction transmission which reduces the speed and multiplies the torque. Thus, the two basic operational variables are screw speed and plug pressure.

According to the manufacturer and industry data, the performance of the screw press scales up linearly with increase in the screw size, so a machine with much higher throughput will provide comparable moisture removal performance.

An exemplary working example of moisture reduction using a screw press apparatus is described in Example 1 below.

A vertical rotary press is a machine consisting of two large vertical concave disks mounted off-axis so there is a large gap between the disks at the top (where material is fed) and a very small gap at the bottom (where material is ejected). The disks are surrounded by a screen corner through which moisture is emitted. The disks are rotated typically using a chain drive to an electric motor. A commercially available example is the “V-Press” manufactured by Bepex Corporation, Minneapolis Minn.

Material added from the top of the press is carried and progressively compressed as the discs rotate. Typical moisture removal is on the order of 7% to 8%. This is less removal than a screw press, however, this may be offset by the much higher wet cake processing rate the vertical rotary press is capable of relative to the equipment cost.

Mechanical moisture reduction is an efficiency enhancement not essential to the overall operation of the DDGS processing line. It can be omitted, with the microwave dryer line performing the additional drying in the event the screw press is down for repair or maintenance, or if an overall simplification is desired for cost, space, or other reasons. This would come at the cost of higher electric energy cost for the microwave drying line.

### Pelletizing

This stage forms the wet cake product into a pellet shaped form prior to drying using microwave energy. The purpose of pelletizing is to increase the density of the DDGS product in order to improve the handling, storage and shipping characteristics. It also improves the action of the microwave dying process by breaking up the material into consistent small pieces which more readily and uniformly release moisture.

There may be situations where pelletizing is not needed, for instance if an ethanol plant is co-located with an animal feeding operation which consumes most or all of the DDGS produced. In this case, the distiller's grain may be directly transferred from the screw press to, and spread on, the intake belt of the microwave dryer.

There are at least two useful methods of pellet forming, a low pressure extrusion system (the preferred method), or a conventional pellet mill. The skilled artisan will understand that the claimed methods are not limited and that other known methods of pellet formation may be utilized within the scope of the claimed subject matter.

Compared to high pressure extruders, low pressure extruders have many advantages. They do not use or create high temperatures, use much less energy, have much higher throughput, and are less costly. A low pressure extrusion system consists of a relatively wide diameter screw with flights of increasing pitch enclosed in a cylindrical housing. The shaft is rotated by a variable speed electric motor through a gear reduction transmission which reduces the speed and multiplies the torque. Part of the screw is exposed as a product intake. The output end of the cylinder is enclosed except for an exhaust outlet. The exhaust outlet is fitted with a perforated plate. The number, size, and pattern of the holes in the plate determine the configuration and number of pellet beads formed. The pellet beads tend to beak up into short lengths as the product is transported and processed, however, if precise uniformity is desired, cutting blades can be fitted to the extruder output.

Wet cake is fed into the rotating screw, and increasingly pressurized due to the narrowing screw pitch. One or more internal plates may be installed to increase working pressure and therefore adjust the amount of compaction of the extruded wet cake. The pressure pushes product out of the end and through the plate. Each hole emits a stream of formed pellets which are laid directly on the belt feeding the microwave drying line. The diameter of the holes in the plate is selected according to the desired pellet diameter of the finished product. Preferred pellets can have a diameter of approximately ⅛″ to ½″. The pressure of material fed can be adjusted accordingly varying the speed of the extruder's motor and/or installation of internal pressure plates. The pressure adjustment is useful to achieve an optimal compaction of the pellets produced. The extruder can be mounted vertically so its output drops directly on the input section of the microwave drying line belt. This is a low temperature process, no heat is added, and little frictional heat is generated.

Wet cake is a naturally adhesive substance and does not require a binding agent for pelletization. The microwave “treating” process causes the pellets to harden while retaining the desirable golden color.

Certain species of animals require or prefer pellets of a certain size. This low pressure pellet forming system can be rapidly switched between different pellet sizes in order to produce a species-specific DDGS product.

An exemplary working example of the pelletizing step is described in Example 2 below.

### Microwave Drying System

The purpose of the microwave dying system is threefold:
I. To reduce the moisture content of the DDGS to the range of about 10% to 12% so it can be stored for extended periods without spoiling, and so it consumes less volume.
II. Optionally to enhance the action of the added enzymes by breaking down the cellular substrate, thus providing a significant nutritional value improvement, on the order of 15% to 20% (see U.S. Pat. No. 6,274,178, the entire text of which is incorporated herein by reference);
III. To fix the pellets in their final hard form. This improves the ability to bulk package and/or ship the DDGS product.

Industrial Microwave Ovens

Industrial microwave ovens have been widely used for at least fifty years. Primary applications include cooking and processing food for human consumption, and drying various materials such as wood products.

One type of industrial oven line particularly suitable for the present invention comprises several separate cooking ovens (cavities) arranged in a horizontal feed line. In this arrangement, it is anticipated that five or more ovens will be used on each line, depending on the design capacity. Each oven is a seamless welded steel box approximately one square meter, however, dimensions can vary. The front of each oven has an access door and the oven is designed to prevent leakage of microwave energy.

A continuous belt to move material extends through slots located on both sides of the each oven. The boxes are connected by enclosed plenums which the belt moves through. The first and last ovens have pin-type radio frequency chokes which prevent the leakage of microwave energy so the ends of the belt may be in the open for product loading and unloading. One or more screened vent openings are provided for removal of exhaust vapors. These vents are connected to high capacity blowers and a duct system.

At the top of each oven are one or more rotating dipole antennas which emit microwave power into the oven cavity. The rotation of the antenna is to ensure even distribution of microwave energy throughout the oven. The antenna is connected via rectangular waveguide to a transmitter unit which generates the microwave energy. Each oven may be fed by one or two transmitters, depending on the design capacity.

The transmitter generates microwave energy using a water cooled magnetron tube. Each transmitter typically generates up to 75 kilowatts of power with a conversion efficiency of about 85%.

The high voltage power supply for the magnetron steps up 480 volt 3 phase mains voltage (via a power control circuit) to 10 kilovolts, which is converted to DC current using a high voltage rectifier bridge. In an exemplary application a frequency of 915 megahertz is used, which allows deep material penetration and high power generation.

The output of the magnetron tube is connected via a three port device called a “circulator”. It routes radio frequency (RF) energy to the oven feed waveguide and/or a water cooled dummy load. The circulator provides protection to the system by automatically diverting reflected (reverse) RF energy to the dummy load. This could occur due to an insufficient load in the oven, arcing in the oven, damage to the waveguides or oven, or other fault conditions.

The transmitter cabinet also houses a process control computer and associated electrical controls. It communicates with a touch screen LCD user interface located on the oven. The computer automates the operational, monitoring, and safety features of the transmitter and the associated oven. The computer can precisely control the microwave power output with one kilowatt resolution in either pulsed or continuous modes. The computer also controls the belt speed to control drying speed for pellets.

Mechanism of Microwave Drying

In conventional convection heating, the heat source causes the molecules to react from the surface toward the center, so that successive layers of molecules are heated in turn. This process results in every molecule in the material being heated to some degree and commonly results in the outer layer of the material becoming over-dried. In an effort to prevent damage to nutrients from over-drying, rotary kiln and ring dryers attempt to expose all surfaces of the granular material being dried to the heated air stream. This maximizes both heat transfer into the particle and mass transfer of moisture out of the particle.

Microwave ovens perform volumetric heating by electromagnetic transfer of energy to a workload. As microwaves pass through a material, polar molecules move to align their positive and negative charges with the electric field. Switching the field at 915,000 times per second forces polar molecules such as water, sugar and fat to oscillate. The molecular motion produces a heating effect due to friction, between vibrating molecules and the surrounding material. Due to the speed at which the microwaves travel, the heating effect is uniform throughout the volume of homogeneous materials.

The level of excitation (and therefore heating) of molecules in the workload depends on the dielectric properties of the material. Water, in particular, strongly absorbs microwave energy. Drying of wet cake is an example of a near-ideal application of microwave heating.

Unlike conductive heating as performed by gas dryers, only the workload is heated. Any heating of the surrounding air or the oven enclosure is small and incidental. Heating efficiency by microwave energy is on the order of 95%. Utilizing industrial microwaves for processing animal feed eliminates the need for elaborate systems such as ring dryers and rotary kilns. Among all types of heating, dielectric (microwave) heating is the only system that can produce a far higher temperature inside a product than on its surface. The peak temperature at the surface will never exceed the temperature required to allow for water to evaporate from its surface.

Normally, drying a wet substance involves heating it to the boiling point of its liquid part. This temperature requires a certain amount of energy and is linear until the boiling point is reached. In order to cause the phase change from liquid to gas, a significant amount of additional energy which does not cause further temperature rise (known as the enthalpy of evaporation) must be added. Customary calculations of energy needed for microwave drying take into account the latent heat of evaporation as if the material to be dried was a simple container of water to be boiled off.

However, in the course of experiments leading to certain elements of the present invention it was surprisingly discovered that drying wet cake by microwaves used much less energy than was predicted by this method, thus leading to a different explanation as to its action.

### Microwave Forced Evaporation

In the claimed process, the drying (and all other processing) is conducted at a low temperature, preferably not exceeding about 75° C., in order to avoid burning the product and to protect any enzymes or nutritional enhancements which may have been added to the DDGS.

Evaporation is a process where liquid molecules spontaneously undergo a phase change to the gaseous state without being heated to the boiling point. Many factors affect the rate of evaporation including temperature, surface area, surface tension, surrounding air flow, air pressure, air temperature, liquid concentration, etc. The classic equation that describes the evaporative process is complex with many variables. In practice, it is extremely difficult to apply the evaporation equation to a substance such as wet cake, which is a complex mixture of many liquid and solid components. Therefore, the only practical approach is to describe the evaporative process of wet cake by empirical observation.

The process described herein provides a nearly optimal presentation of product for evaporative drying. DDGS is pelletized into small units which provide a large surface area. There is a high airflow around the product provided by the ventilation system, and perhaps more relevant, it is quickly and thoroughly penetrated by microwave energy. Excitation of the liquid molecules by microwave energy appears to occur widely and uniformly, resulting in rapid evaporation. Having a higher dielectric constant than the solids in the wet cake, the liquids absorb much more energy, allowing the heat needed for a change of state to gas (the latent heat of evaporation) to occur at the molecular level. There is very little heating of molecules of the solids present in the wet cake.

Another beneficial mechanism relates to the fact that moisture tends to migrate from wet to dry and from hot to cold. Wet cake heated by a microwave process is warmer inside, and evaporation occurs more at the cooler surface. As a result, the temperature and moisture gradients are both in a favorable direction. It is noteworthy that in conventional dryer, heat travels from the outside to the inside, so hot-to-cold gradient is reversed and thus the migration is hindered.

Moisture evaporating continuously from the product surface lowers the surface temperature because of the evaporative cooling effect. This effect helps keep the temperature of the wet cake to be kept low so the product and additives are not damaged.

### Inter-Oven Plenums

After the DDGS product is heated and moves out of the microwave oven, it continues evaporation. The “steaming” rate is significant and readily visible. This results in additional “free” drying as no energy input is used. In order to provide a space for this evaporation to occur, a fully enclosed plenum can be provided in between each microwave oven. The belt moves product through each plenum in between each oven. The nominal length of the plenum is approximately the same as the width of the heating ovens (about 1 meter). A longer plenum will increase the free drying effect but at some point may become physically unmanageable. The last plenum also serves as an RF choke which prevents egress of microwave energy where the belt emerges at the end of the line.

One or more screened vents on the top of the plenum connected to an exhaust blower may be provided. The exhaust of the blowers is connected to the vapor collection and recycling system.

Design of the ventilation system to maximize airflow across the product can be achieved to obtain optimal performance of the system.

### Input Instrumentation and Process Control Computer

The conveyor belt feeding into the microwave drying line is preferably equipped with the following sensors:
I. A “product present” sensor to indicate when product is about to enter the first oven. This would typically be of the optical interrupter type.
II. A temperature sensor used to continuously determine the temperature of the incoming product. This would typically be of the linear infrared type. An example is the Raytek MP50 linescanner. A linear sensor provides more reliable data in the presence of randomly distributed “hot spots”.
III. A non-contact moisture sensor to continuously determine the moisture content of the incoming product. This would typically be of either the near-infrared (NIR) or microwave types.
IV. A temperature sensor used to continuously determine the temperature of the processed product. This would be similar to or the same as (II) above.
V. A non-contact moisture sensor to continuously determine the moisture content of the processed product. This would be similar to or the same as (III) above.
VI. These sensors are interfaced to the process control computer. The purpose of the “product present” sensor is to indicate when product will reach the heating cavity so the microwave transmitter power can be scaled up properly, or if the supply of product ceases.

The humidity and moisture sensors are also interfaced to the process control computer. The raw data is first scaled, normalized, and filtered appropriately. The sensor data is input to a continuously executing adaptive algorithm which sets the optimal belt speed and power levels for each heating cavity.

The computer program is designed to accomplish the following:
I. To produce a dried product with a specific preset moisture content. This produces a much more consistent product than DDGS dried with current hot air drying systems.
II. To prevent overheating of the product that could degrade the product or any added enzymes and nutrients.
III. To minimize electrical energy consumption by use of optimized power profiles for the transmitters (such as load balancing).
IV. To adjust for conditions where one or more microwave transmitters or the screw press are off line due to a fault condition or for maintenance. This allows the plant to benefit from increased uptime.

The computer is also interfaced to local process controllers which operate the material handling systems and the screw press. This allows end to end control of product flow. It also provides supervisory and safety monitoring functions.

### Vapor Collection and Recycling

In a conventional gas-fired rotary or kiln dryer, all of the moisture removed from the DDGS is released into the atmosphere, along with volatile organic compounds (VOCs) and the natural gas combustion products. This wastes a significant portion of the water used by the plant and adds to the plant's carbon footprint. Expensive thermal oxidizers are often used to remediate the VOCs.

During the microwave drying process, vapor from the DDGS is released into the closed cooking ovens and interconnecting plenums. One or more powerful exhaust fans remove the vapor at a high rate. This improves the efficiency of the microwave heating as less energy is consumed heating moisture already removed from the product.

The output of the exhaust fan(s) are connected and combined in a network of ducts. The output of the duct is filtered to capture particulates, and then routed to a condenser system which returns the gases to a liquid state and recycled within the ethanol plant. The condensate may have a significant ethanol content, which may be reprocessed and captured within the plant.

The amount of liquid reclaimed depends on the efficiency of the evaporator. A 50 million gallon per year ethanol plant produces approximately 166,000 tons of DDGS per year. Assuming a 50% reduction in moisture content, approximately 12.8 million gallons of water are removed from the DDGS. If the evaporators have a 75% efficiency, 9.6 million gallons of water can be recovered and recycled. All of this water is lost using conventional natural gas fired dryers.

### Air Recirculation System

Air and other vapours flowing through the microwave cavities are warmed during the material heating process. After being routed through the condenser the air is cooled somewhat, but will still be warmer than the ambient atmosphere. Warm air has a higher moisture carrying capacity and thus is beneficial to the evaporative process. The output of the condenser may be warmed by a boost heater which pre-heats air, preferably to 250° to 350° F., before being re-used as intake air by the microwave heating line. The heater may be powered by electricity, gas, plant process steam, or any other useful plant waste heat source.

Even though the intake air temperature exceeds the maximum desired material temperature, the material keeps relatively cooler because of surface evaporative cooling at the material/air boundary and therefore stays within desired limits.

This closed system has several advantages including: 1) containment of all potential emissions; 2) energy efficiency; and 3) reduction of odors in the vicinity of the plant.

### Microwave Dryers for New Ethanol Plant Installations

The higher electrical demand for microwave dryers will increase the electrical distribution equipment costs for an ethanol project when compared with rotary dryers. However, a number of significant cost savings may be realized from using microwave dryers to offset these higher electrical costs. Potential installation construction cost reductions are: Minimal foundation requirements—unlike rotary kiln dryers, the weight of the microwave systems does not require a specialized foundation.

Building size—microwave units require less space and reduce plant construction costs.

Building height—the facility housing microwave dryers may be single story, with dedicated electrical rooms for the microwave transmitters located adjacent to the dryers.

Reduction in the size or elimination of the need for thermal oxidizers because there are no combustion products, and all exhaust products can be captured and reprocessed.

### Microwave Dryers for Rotary Kiln Replacement

When replacing a rotary kiln dryer with a microwave dryer, the electrical system upgrades should be the first consideration. Coordination with the electrical utility should be done early in the design process.

A dedicated structure to enclose the microwave drying equipment can utilize the space formerly occupied by the rotary kiln. Alternatively, the microwave drying line components can be built into standard 40 foot modular shipping containers. This would offer many advantages including: elimination of the need for a dedicated building; the possibility to replace existing dryers incrementally; and the cost savings associated with the ability to pre-install, pre-wire, pre-plumb, and pre-wire the equipment prior to shipment to the plant site.

Utilizing industrial microwaves for drying the co-products of both Dry Milling and Wet Milling is technically feasible at this time. Energy cost savings coupled with the reduction in losses from over drying will help minimize plant operating costs. The enhanced appearance and nutritional value of livestock feeds produced using these methods will be a valuable asset when marketing feed to livestock producers.

### Use of Renewable Energy Sources

By changing the basic energy source for drying DDGS from natural gas to electric power there are more possibilities to use renewable or other “green” energy sources to power the microwave line.

Many ethanol plants are located in close proximity to the large wind power fields that have been constructed in the Upper Midwest of the US. Alternatively, it is estimated that 3 to 5 windmills actually located at the ethanol plant site could power the drying operations of a 50 million gallon per year plant.

Cogeneration of electric power from biomass-fuelled systems is also a possibility. In other areas of the United States, electric power is generated by hydroelectric or nuclear sources that do not contribute to the greenhouse effect.

### Reduction of Harmful Microorganisms in Livestock Feed Production

Microwave heating to temperatures between 72° C. to 75° C. for fifteen to twenty minutes resulted in the destruction of unwanted microorganisms that is faster than the degradation of product characteristics. The ability to control drying temperatures allows for the ability to eliminate pathogens and unwanted enzymes that may inhibit nutrient utilization by livestock.

### Systems

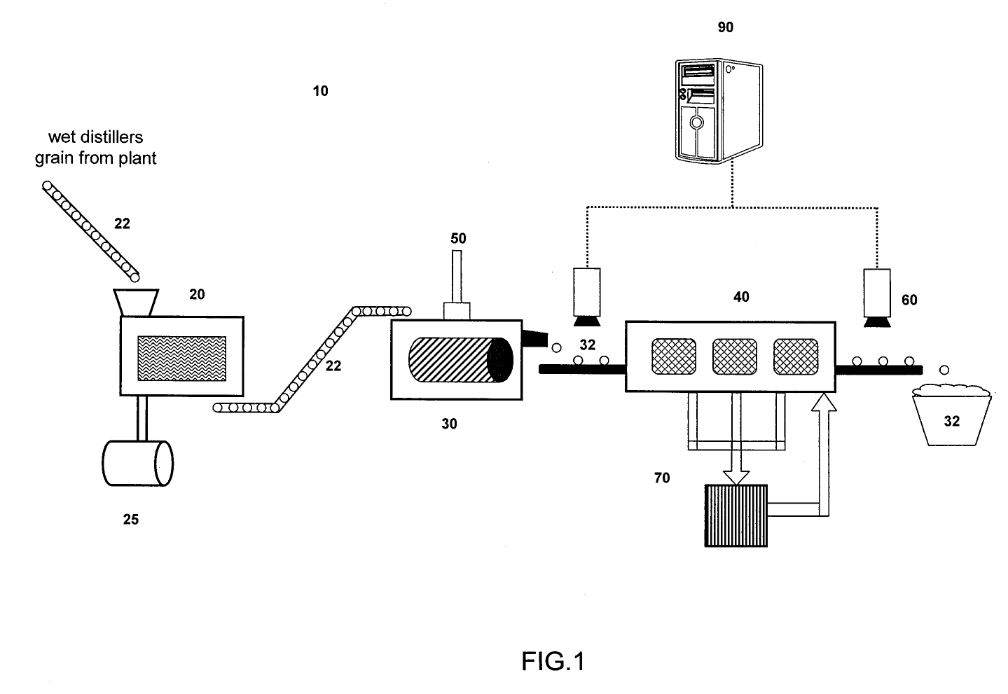

FIG. 1 shows a schematic of a system 10 for forming a supplemented pelletized animal feed from distillers' grain according to the present invention. The system 10 includes a dewatering apparatus 20 for reducing moisture content of wet distillers' grain, a pellet-forming apparatus 30 for forming pellets 32 from the distillers' grain, a microwave oven 40 for removing moisture from the pellets 32, and transporting systems 22 in the form of a conveyor for moving material through the system 10. A port 50 is provided on pellet-forming apparatus 30 for adding supplements to distillers' grain. A vapour collection system 70 is positioned to collect moisture removed from the pellets 32 in the microwave oven 40, and to recirculate collected air and vapours.

Liquid co-products such as micro-fines, water, corn oil, and ethanol can be collected from the dewatering apparatus 20 in a suitable collector 25. Dried pellets 32 are collected at the end of the system 10 and then packed or shipped out for use.

The system 10 is under control of computer 90 so the supply of the distillers' grain, supplement addition, pellet formation, moisture removal and moisture collection can be automated.

Monitors 60 such as IR temperature scanner and NIR moisture analyzer are positioned to provide measurements to the computer 90 which can then control the system 10.

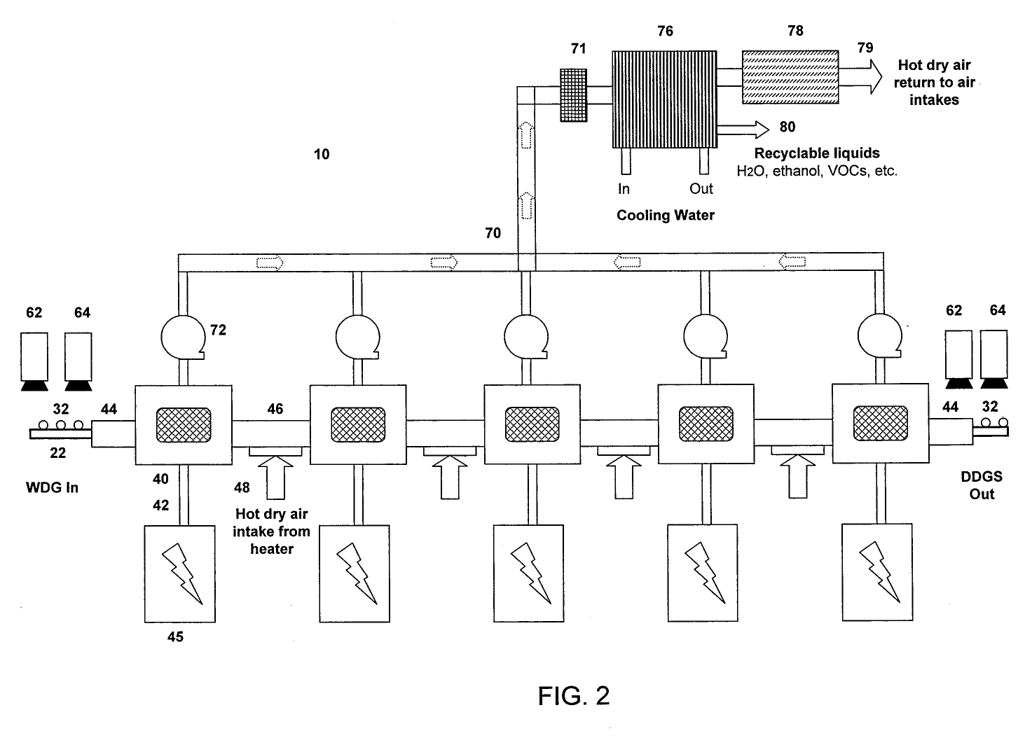

FIG. 2 shows more detail on the system 10 for microwave drying and vapour collection. A number of microwave ovens 40 are positioned in series. Each oven is powered by one or more microwave generators 45, which is connected to each oven by a waveguide 42.

Transporting system 22 in the form of a conveyor belt moves pellets 32 through the microwave ovens 40. At the entry of the first microwave oven 40 and exit of last microwave oven 40 there is positioned a suitable radio frequency choke 44. Between adjacent microwave ovens 40, there are plenums 46. Exhaust blowers 72 are positioned at each oven 40 to remove moisture and vapours released by the microwave treatment and to be passed to the vapour collection system 70. Air and vapours collected in the main duct of the collection system air are passed through though air filter 71 to remove particulates. The condenser in the vapour collection system 76 allows collection of liquids removed from the treated pellets 32. Warm dry air exhausted from the condenser outlet 79 is reheated by heater 78 and fed back to the microwave line air intakes 48. Collected liquids are routed from the condenser outlet 80 for recycling in the plant.

To measure the moisture removal process, IR temperature detector 62 and NIR moisture scanner 64 are each positioned near the entry of the first microwave oven 40 and near the exit of last microwave oven 40. Measurements are provided to computer to control the process and ensure the system 10 is functioning as required.

### EXAMPLES

### Example 1

### Use of Screw Press Apparatus to Reduce Moisture Content

The screw press used for an initial study was an “Agri-Press” manufactured by Press Technology, Inc., Springfield, Ohio, having a 6″ diameter screw, a 3:1 pitch ratio and a linear screen having 0.008″ screen spacing. The skilled artisan will realize that other commercially available screw presses may be utilized in a high throughput ethanol plant operation.

Starting material was 40.7 kg of fresh wet cake obtained from the Pine Lake Corn Processors ethanol plant, Steamboat Rock, Iowa. The wet cake's temperature was 51° C. with a wet basis moisture content of 67.7%. This wet cake was fed into the screw press. The screw speed was set to at 0.8 RPM and an indicated cone pressure was set to 70 PSI. After pressing, the product output was sampled and tested. The output wet basis moisture was tested and determined to be 59.7%, or a reduction of (1−(59.7/67.7))=11.8%. The liquid product removed consisted of water, ethanol, corn oil, and very fine un-dissolved solids weighing 13.48 kg. Laboratory analysis of the liquid product was:

| | |
|---|---|
| Liquid | 76.31% |
| Fat (corn oil) | 2.67% |
| Solids | 21.03% |

This rich co-product could be further processed or fed back to the ethanol plant's stillage evaporator to further enrich the DDGS. It is anticipated that through further refinement, reduction of moisture of 10% absolute (wet basis) should be readily achievable.

### Example 2

### Pelletizing

An initial study was conducted to confirm the low pressure flowability of wet cake. In order to simulate the operation of a low pressure screw extruder, a 2.5 gallon steel pressure tank with a removable top was modified as follows.

Using an existing threaded connection on the top cover, a compressed gas input port with a regulator and pressure gauge was fitted.

A 1 inch hole was punched near the bottom of the tank and a ¾″ NPT brass fitting was brazed in to act as an outlet port.

A four inch length of ½″ NPT brass pipe was connected to the tank's output port.

The other end of the output pipe was connected to a side fed machined aluminum 10-port manifold, each port being threaded for 9 mm NPT. A set of brass ⅜″ NPT threaded plugs drilled with ⅛″ orifices were prepared.

The tank was filled with approximately 2 gallons of cold wet cake and sealed. The tank was then placed on a hot plate until the temperature was approximately 50° C. at the bottom and 20° C. at the top.

A set of four ⅛″ orifice plugs was installed in the manifold. Solid plugs were installed in the unused ports. Compressed carbon dioxide was slowly released into the tank. When an indicated pressure of 40 PSI was reached, a smooth continuous flow of ⅛ inch diameter product beads was observed. Tests with other configurations established that less than 10 PSI of pressure per orifice produces a good product flow demonstrating that wet cake extrudes well at low pressure.

In a second study, wet cake was processed using an “Extrudamix” low pressure extruder manufactured by Bepex Corporation, Minneapolis Minn. This machine had a 6″ diameter interrupted flight screw and an output plate having approximately 100 holes of about ⅛″ diameter in a circular pattern.

Approximately 40 lbs of wet cake with 67% moisture content (wt/wt) at 25° C. was fed into the intake port of the extruder with a medium-low motor speed. The extruder expelled uniform, fully formed product beads from all holes. The screw speed was then increased to a high setting, and the extruder continued to perform consistently, clearly indicating the high throughput potential of the device. No temperature increase in the material processed was observed. It should be noted that this particular machine was equipped with injection ports for liquid additives, and although not used in this experiment, could be used to combine the enzyme/nutrient additive mixing step with the product forming step.

### Example 3

### Determination of Microwave Power

A study was conducted to determine the energy required and rate of evaporation of wet cake using a microwave oven.

The equipment used was a 60 kilowatt capacity industrial microwave oven manufactured by AMTek Microwaves, Inc, Cedar Rapids, Iowa. The oven was equipped with a bottom vent and exhaust blower rated at 250 cubic feet per minute.

Fresh DDGS wet cake was obtained from a local ethanol plant. The wet cake nominal temperature was 45° C.

A carefully measured quantity of crumbled wet cake was loaded onto the belt. Additional portions of wet cake were loaded on the belt ahead of and behind the test sample to compensate for the fact that the transmitter automatically ramps power up to and down from a power preset as product enters and exits the oven. The power was applied in a continuous mode.

The test sample was laid on the belt 30 cm wide, 273 cm long, and about 1 cm thick. The belt speed was 122 cm/minute for all runs. Therefore the product was processed in 273/122=2.238 minutes. Results are set out in the Table 1 below.

TABLE 1

| | | | | MC | Mass | Water | Moisture |
|---|---|---|---|---|---|---|---|
| Run | Power | MC In | Mass In | Out | Out | Removed | Reduction |
| # | (kw) | (%) | (kg) | (%) | (kg) | (kg) | (%) |
| 1 | 10 | 67.45 | 5.128 | 50.92 | 3.508 | 1.620 | 16.53 |
| 2 | 15 | 67.30 | 5.184 | 42.38 | 2.990 | 2.194 | 24.92 |
| 3 | 20 | 67.64 | 5.608 | 33.48 | 2.552 | 3.056 | 34.16 |

It is clear from the results in Table 1 that the water removal is a linear function of microwave power applied.

Considering run #3, it will be noticed that 3.056 kg of water was removed in 2.238 minutes which is equivalent to ((60 min/2.238 min)*3.056 kg))/20 kw=4.097 kg of water removed per kilowatt hour.

One kilowatt hour equals 3413 BTUs, thus 3413/4.097=833 BTU per kg of water evaporated, or 378.63 BTU/lb.

Given this drying factor, and specifying: a) the moisture content of the incoming wet cake, b) the desired moisture content of the dried product, and c) the amount of product to be processed, it is a straightforward exercise to calculate the total required microwave power capacity and the number of transmitters and ovens needed by a given processing line.

A second study was conducted similar to the one above, except a fixed amount of wet cake was repeatedly dried at a constant 10 kilowatt power level on the same equipment. The purpose of this study was to verify the linearity of the drying process as the water content of the product decreases.

Fresh DDGS wet cake was obtained from a local ethanol plant. The wet cake nominal temperature was 53° C.

A carefully measured quantity of crumbled wet cake was loaded onto the belt. Additional portions of wet cake were loaded on the belt ahead of and behind the test sample to compensate for the fact that the transmitter automatically ramps power up to and down from a power preset as product enters and exits the oven. Ten kilowatts of power was applied in a continuous mode.

The test sample was laid on the belt 30 cm wide, 273 cm long, and about 1 cm thick. The belt speed was 122 cm/minute for all runs. Therefore the product was processed in 273/122=2.238 minutes. Results are set out in the Table 2 below.

TABLE 2
Mass

| Run | Mass | MC % |
|---|---|---|
| Start | 5.168 | 66.08 |
| 1 | 3.480 | 50.90 |
| 2 | 2.660 | 36.78 |
| 3 | 1.778 | 2.62 |

The data confirms that the moisture content drops proportionally to the microwave power exposure down to the point where the product was very nearly completely dry.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A process for producing a pelletized animal feed comprising:
a) treating distillers' grain to reduce moisture content;
b) forming pellets from the treated distillers' grain; and
c) exposing the pellets to microwave energy to reduce moisture content to form a pelletized animal feed.

2. The process according to claim 1 wherein the distillers' grain is treated mechanically to reduce the moisture content.

3. The process according to claim 2 wherein mechanical treatment uses a screw press or a vertical rotary press.

4. The process according to claim 2 wherein to the moisture content is reduced from about 65% to about 55% (wt/wt).

5. The process according to claim 1 wherein the pellets are formed by a low pressure extruder or pellet mill.

6. The process according to claim 1 further comprising:
i) adding a supplement to the distillers' grain.

7. The process according to claim 6 wherein the supplement is selected from the group consisting of enzyme, vitamin, and/or mineral.

8. The process according to claim 6 wherein the enzyme is selected from amylase, alpha amylase, glucoamylase, phytase, phosphatase, carbohydrate hydrolyzing enzymes, xylanase, cellulose and hemi-cellulase and mixtures and combinations thereof; the vitamin is selected from vitamin A, vitamin D, vitamins of the B Group and Vitamin E and mixtures and combinations thereof, and the mineral is selected from sodium chloride, calcium, phosphorus, sulfur, potassium, magnesium, manganese, iron, copper, cobalt, iodine, zinc, molybdenum and selenium and mixtures and combinations thereof.

9. The process according to claim 6 wherein the enzyme, vitamin, or mineral is added at a concentration ranging from parts per million to in the case of enzymes up to 5000 g per 1000 kg of material.

10. The process according to claim 1 wherein the microwave energy exposure is carried out such that the temperature of the pellets is from about 50° C. to less than about 90° C.

11. The process according to claim 10 wherein the temperature is about 60° C. to 80° C.

12. The process according to claim 11 wherein the temperature is about 65° C. to 78° C.

13. The process according to claim 12 wherein the temperature is about 70° C.

14. The process according to claim 1 wherein the moisture content of the pelletized animal feed ranges from 15% to about 10% (wt/wt).

15. The process according to claim 1 further comprising:
ii) capturing and condensing vapors from the moisture removed during the moisture reduction process.

16. A system for forming a pelletized animal feed from distillers' grain comprising:
a) dewatering apparatus for reducing moisture content of distillers' grain;
b) pellet-forming apparatus;
c) microwave oven; and
d) transporting system for moving material through the system.

17. The system according to claim 16 further comprising:
i) mixer for adding supplements to distillers' grain.

18. The system according to claim 16 further comprising:
ii) device for measuring moisture content of distillers' grain, pellets or pelletized animal feed.

19. The system according to claim 16 further comprising:
iii) exhaust system for removing moisture from microwave oven.

20. The system according to claim 16 further comprising:
iv) apparatus to collect moisture or water removed from distillers' grain or pellets.

21. The system according to claim 16 further comprising:
v) a computer to run an adaptive real time control algorithm.

22. A pelletized animal feed produced by the process according to claim 1.

23. A pelletized animal feed produced by the system according to claim 16.
